(19) United States
(12) Patent Application Publication
(10) Pub. No.: US 2005/0074524 A1
(43) Pub. Date: Apr. 7, 2005

(54) Fortified food product and method for producing thereof

(76) Inventor: Urban Cavazos, Corpus Christi, TX (US)

Correspondence Address: DAVID G. HENRY, 900 Washington Avenue, 7th Floor, P.O. Box 1470, Waco, TX, 77603-1470, US

(21) Appl. No.: 10/678,968

(22) Filed: Oct. 3, 2003

(51) Int. Cl. A23L 1/30

(52) U.S. Cl. 426/72

(57) ABSTRACT

A fortified food product and method of manufacture. The present invention provides a pleasant tasting, nutritionally sound meal replacement where nutritional integrity is maintained during storage and transport. While useful for people of all ages, the present invention is thought to be most beneficial to people undergoing medical recovery, people who have sensitive digestive tracts, and people living in areas lacking an adequate supply of nutritionally rich foods.

### BACKGROUND OF THE INVENTION

1. Field of the Invention

Applicant's invention generally relates to an improved fortified food product and method of manufacture, more particularly, it relates to a product that contains a spectrum of necessary vitamins and nutrients and which eliminates many common problems associated with such food products. The present invention further provides a cost effective method, and a product that is easily distributed to the consumers who would benefit most; specifically children, the elderly, the poor, the disabled and medical recovery patients.

2. Background Information

The need for a convenient and cost-effective nutritional food product is greater than it has ever been. Today, more than ever, people are neglecting their own nutritional needs, both at work and at home. The fast and hectic lifestyle of modern society often forces people to “eats out” several times a week. In fact, a recent study suggests that in the United States, it is common for a single person or family to consume the majority of their meals inside restaurants or food chains rather than in there own home. As such, and perhaps understandably, the nutritional value of the meals they consume takes on a secondary role to the convenience and availability of the meals.

However, the problem does not end there. Nutritional deficiency has spread through-out our school system. In fact, a similar study suggests that the breakfasts and lunches provided by our school systems fail to meet established nutritional requirements. These meals typically are lacking in essential nutrients, are low in protein, and very high in fats and sugars. By thoroughly saturating our children with unhealthy eating habits at such an early age, we are effectively setting them on a course that will lead to premature health problems. These problems range from high blood pressure and stroke to diabetes and obesity.

The product of the present invention is thought to be most beneficial to medical recovery patients, the poor, the elderly, the disabled, and children. As such, the present invention is envisioned and structured so as to allow large-scale distribution in hospitals, schools, or shelters and ration lines. The present invention may be shipped in a dry powder form, and then mixed and immediately dispensed to consumers, or, may be distributed in concentrate or soft-serve form. Further, the product of the present invention is cost effective and structurally stable. As such, its distribution range is far reaching and its shelf life is uncommonly long. In light of the above, the present product may be most beneficial for delivering large quantities of nutritious food to hard to reach places, where it is often needed the most.

The present invention encompasses several physical embodiments including dry powder, soft serve ice cream, pudding, and frozen concentrate. Such products, when fortified, are often associated with poor nutritional and taste quality. However, the product of the present invention has eliminated that problem. The present invention, in its most preferred form is dairy-free. As such, the present product can be transported over great distances and long periods of time while maintaining its nutritional integrity. Also, elimination of any dairy product removes problems associated with moving such dairy products across national borders. Finally, the present invention may be dispensed to people with sensitive digestive tracts or who are lactose intolerant. People who have problems with digesting dairy products will easily consume the present product.

Fortified food products are known in the art. Despite this, the product and method of the present invention is novel in light of the known products. One of the most difficult problems in maintaining a healthy diet complete with vitamins and nutrients is the fact that most dessert or snack products, which satisfy a craving for a sweet food, are severely deficient in essential vitamins and nutrients. In addition to the nutritionally deficient nature of many sweet foods, the organoleptic properties of fortified foods such as taste, and mouth-feel are not satisfactory. The present invention relates to a food product having good organoleptic properties such as taste, mouth-feel and appearance, and if required low available carbohydrate content. In addition, nutritionally fortified products tend to have a grainy mouth-feel which detracts from their acceptability as a food supplement in spite of their potential health benefits. However, embodiments of the present invention has essentially eliminated that problem. The soft serve and frozen food product has an excellent smooth, creamy mouth-feel, small ice crystal size and excellent flavor.

Further, a common problem associated with known fortified nutritional food products is their tendency to breakdown during the storage and transport process. The present invention is unusually durable, that is, the product maintains its nutritional integrity value when stored for long period of time and when subjected a wide range of temperatures.

There are severe nutritional deficiencies in the meals commonly eaten by most people in the United States. Further, it is difficult to efficiently provide a nutritious food product that can be consumed by disabled people, and people recovering in health care facilities. Moreover, it is difficult to provide nutritional products to the impoverished in a cost effective manner. Accordingly, a great need exists for an improved method and food product that does not contain an unpleasant after taste and will maintain its nutritional integrity during storage and transport; and where the food product making process is both efficient with respect to time and production costs, and where the process does not create unnecessary production waste.

### SUMMARY OF THE INVENTION

In view of the foregoing, it is an object of the present invention to provide a method of fortified, nutritional food production where the product maintains its nutritional integrity during the storage and transport process.

It is another object of the present invention to provide a method of fortified food production whereby the resultant product is free from any unpleasant after taste.

It is another object of the present invention to provide a method of fortified food production whereby the resultant product is easily digested by people with sensitive digestive tracts.

It is another object of the present invention to provide a cost effective method of fortified food production.

It is another object of the present invention to provide a time effective method of fortified food production.

It is another object of the present invention to provide a method of fortified food production that reduces adverse effects on the environment through the elimination of wasted production materials.

It is another object of the present invention to provide a fortified food product where the fortified food maintains its nutritional integrity during the storage and transport process.

It is another object of the present invention to provide a method of fortified food production whereby the resultant product is free from any unpleasant after taste.

It is another object of the present invention to provide a method of fortified food production whereby the resultant product is easily digested by people with sensitive digestive tracts.

It is another object of the present invention to provide a fortified food product that is cost effective to produce.

It is another object of the present invention to provide a fortified food product that is time effective to produce.

It is yet another object of the present invention to provide a fortified food product that reduces adverse effects on the environment through the elimination of wasted production materials.

In satisfaction of these and related objectives, Applicant's invention incorporates a novel combination of ingredients and techniques when making a nutritional, fortified food product. This combination ensures the nutritional integrity of the fortified food product will be maintained during the storage and transport process; and, eliminates any unpleasant after taste traditionally associated with such products.

As will be discussed in the specification to follow, practice of the invention involves a unique combination of ingredients that is comprised of a fortified nutrient-rich base ingredient, a flavoring inclusion, and malic acid. Malic Acid is used to stabilize the mixture, reduce the tangy taste of the formula, and provide an improved finishing taste. The resultant product conveniently provides essential vitamins and nutrients and moderate protein content.

The preferred embodiment of the present invention is dairy-free, as such, the product is available to those who are sensitive to dairy products and the product itself has an exceptionally long shelf-life.

As mentioned, present invention encompasses several physical embodiments. These embodiments include dry powder, an ice cream or soft-serve ice cream product at the dispensing site, a pudding, or frozen concentrate.

The carbohydrate level of the present product can be varied by substituting a carbohydrate sweetening agent such as dextrose, fructose, high dextrose corn syrup, honey, concentrated fruit juices and the like for a part or all of sweetener. The amount of carbohydrate sweeteners can be varied in conjunction with synthetic sweeteners to provide a product with a distinct carbohydrate ratio within broad limits. The minimum amount of available carbohydrate in the product is determined by the amount of available carbohydrate in the natural flavors which can be used to manufacture the product. The products with the lowest carbohydrate levels are products which contain synthetic sweeteners and synthetic flavoring agents.

The product of the present invention is versatile so as to be dispensed in various forms. As such, it is easily incorporated into established regimens, such as those of schools and hospitals. Further, because this product can be easily transported and is not susceptible to adverse storage conditions, the product can be distributed to far reaching, remote places where its need is felt the most. In fact, this product is sturdy enough to be distributed to virtually any place on earth.

### DETAILED DESCRIPTION OF THE PREFERRED EMBODIMENT

The invention relates to a food product and method of manufacture that has particular applicability in the food supplement industry. The food product embodiment comprises a nutrient-rich meal base to which a flavoring is added. The product is placed in appropriate packaging and shipped to its final destination in the dry, fresh, shelf-stable, refrigerated, or frozen state. Upon receipt, the product can be dispensed for consumption, or if received as a dry powder, processed in the desired manner for serving.

There is a wide variation in the formulations or recipes that can be used to prepare the fortified food 10 of the present invention. For example, the preferred embodiment of the present invention is comprised of a nutrient-rich meal base 12 (comprised of vitamin A, vitamin D, vitamin C, Calcium, Iron, Vitamin E, Vitamin K, Thiamin, Riboflavin, Niacin, Vitamin B6, Folic Acid, Vitamin B12, Biotin, Pantothenic Acid, Phosphorus, Iodine, Magnesium, Zinc, Copper, Manganese), a bulking agent 14 (comprised of sugar or synthetic sweetener, maltodextrin, soy creamer, corn syrup solids, safflower oil powder), a flavoring agent 16 (comprised of natural and artificial peach flavor, natural and artificial cream flavor, peaches and cream artificial flavoring, cellulose gum, citric acid, xanthan gum, FD&C Yellow 6), and malic acid 18.

In other embodiments, bulking agent 14 can be non-nutritive or nutritive and are required to provide improved mouth-feel. In low available carbohydrate products, the non-nutritive bulking agents take the place of sugar. If it is required that the product contain sugar, all or a portion of the non-nutritive bulking agent can be replaced by sugar sweeteners. Non bulking agents include compositions such as malitol, sorbitol, hydrogenated corn syrup, inositol and the like. A bulking agent is required to improve mouth-feel of the frozen product or the flavor when the bulking agent comprises a sweetener such as dextrose, fructose or the like. Artificial sweeteners such as (A) water-soluble naturally-occurring intense sweeteners such as dihydrochalcones, monellin, steviosides, glycyrrhizin, dihydroflavenol, and L-aminodicarboxylic acid aminoalkanoic acid ester amides, such as those disclosed in U.S. Pat. No. 4,619,834, and mixtures thereof; (B) water-soluble artificial sweeteners including the soluble saccharin salts such as sodium or calcium saccharin salts, cyclamate salts, the sodium, ammonium or calcium salts of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfam-K), the free acid form of saccharin, and the like, and mixtures thereof; (C) dipeptide based sweeteners including L-aspartic acid derived sweeteners, such as 1-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenyl-glycerine and L-aspartyl-L-2,5-dihydrophenyl-glycine, L-aspartyl-2,5dihydro-L-phenylalanine, L-aspartyl-L-(1-cyclohexene)-alanine, and the like, and mixtures thereof; (D) water-soluble. intense sweeteners derived from naturally-occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose.R™.; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-ldeoxy-beta-D-fructo-furanoside, or, 1′-dichloro-,1′dideoxygalactosucrose; 1′,6′-dichloro-1′,6′-dideoxysucrose; 4-chloro-4-deoxy-alpha-D-galactopyranosyl-1,6-dichloro-1,6-dideoxy-beta-D-fructofuranoside, or 4,1′, 6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′1,6′-tetrachloro-4,6,1′1,6′-tetradeoxygalacto-sucrose; and 4,6,1′,6′-tetradeoxy-sucrose, and mixtures thereof.

The preferred embodiment contains a peach flavoring agent 16 as it is particulary successful in covering any unpleasant after taste. The flavors used in the composition can be natural, artificial or mixtures thereof. Generally to achieve an intense, uniform flavor from batch to batch of the frozen product, a mixture of natural and artificial flavors is utilized. It is preferred that a mixture of natural and artificial flavors be utilized. The natural flavors generally comprise macerated or pureed fruits. Fruits such as peaches, bananas, berries such as strawberries, blueberries, raspberries, plums, kiwi fruit (seeds removed), pears, pineapple, apples, coconut, oranges, lemons are useful.

The flavors imparted to the product by natural flavoring materials are generally intensified or enhanced by addition of artificial flavoring agents and/or flavor enhancers. The artificial flavoring agents and flavor enhancers are added to the composition to provide a more intense and uniform flavor from batch to batch of the frozen product. The artificial flavors and flavor enhancers are well known to one skilled in the food formulation art and are dependent on the particular flavor desired. Examples envisioned in separate embodiment include aldehydes and esters such as acetaldehyde, benzaldehyde, anisic aldehyde, cinnamic aldehyde, citral, neral, decanal, ethyl vanillin, heliotrope, piperonal, vanillin, alpha-amyl cinnamaldehyde, butyraldehyde, valeraldehyde, citronellal, decanal, dihydrocarvyl acetate, eugenyl formate, aldehyde C-8, aldehyde C-9, aldehyde C-12, 2-ethyl butyraldehyde, hexenal, tolyl aldehyde, veratraldehyde, 2,6-dimethyl-5-heptenal, 2,6-dimethyloctanal, 2-dodecenal, p-methylanisol, and so forth. Generally any flavoring or food additive such as those described in Chemicals Used in Food Processing, publication 1274, pages 63-258, by the National Academy of Sciences, incorporated herein by reference, may be used. Other ingredients which may be used in the flavor component include acids such as citric acid, tartaric acid, malic acid and the like acidulants.

In the preferred embodiment, malic acid 18 is used. However, the present product can contain acidulants such as citric acid, tartaric acid and the like. The acids can be partially neutralized and act as flavor ingredients. If low sodium frozen products are required, potassium salts of the acids can be used.

In general, to prepare the product of the present invention, all of the dry items are mixed and blended together in a container or vessel to form a uniform mix to which the liquid ingredients (water and non-dairy ice cream mix) in the preferred embodiment) may then be added. If desired, for bulk operations, measured aliquots of the dry blend may be separated from a large bulk dry mix and then added to the liquid ingredients to form the product. As to be further discussed in the specification to follow, the flavoring inclusions may also be added as dry ingredients to the mix at a ratio of from about 5% to about 20% by weight.

An example meant to show ratios of the combined ingredients is a follows:
Equal amounts of nutrient rich meal base 12, bulking agent 14, and flavoring agent 16, so as achieve a 2-part portion of the entire product;
1/20 part malic acid;
1 parts non-dairy ice cream mix (as known in the art); and
4 parts water

Another example of the present invention would exclude the use of non-dairy ice cream so as to provide a fortified fruit drink. Also, the ingredients may be combined (using substantially less water) and then frozen so as to form a concentrate.

In the preferred embodiment, once the ingredients have been combined so as to form a uniform mixture, the mixture is poured into molds to freeze for approximately five minutes. After all the ingredients have been mixed, the mixture is cooled and frozen in a desired shape. A preferred shape is a bar containing approximately 200 grams of frozen product. The properties of the product are unexpected since the product is fortified with essential vitamins and nutrients and contains very little fat, but has organoleptic properties (smooth, creamy, mouth-feel) associated with fat containing foods.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is therefore contemplated that the appended claims will cover such modifications that fall within the scope of the invention.

1. A fortified food product comprising:
5% to 25% by weight of a fortified meal base,
5% to 25% by weight of a flavoring agent,
5% to 25% by weight of a bulking agent,
0.5% to 3% by weight of acidulant
50% to 80% by weight of water.

2. The fortified food product of claim 1 wherein the acidulant comprises malic acid.

3. A process for preparing a fortified food product comprising the steps of: forming a mixture comprising
5% to 25% by weight of a fortified meal base,
5% to 25% by weight of a flavoring agent,
5% to 25% by weight of a bulking agent,
0.5% to 3% by weight of acidulant
50% to 80% by weight of water.

4. The process of claim 3 wherein the mixture is continuously frozen until in a soft state, then placed in a shaped container and hardened.

5. the fortified food of claim 1 in the form of a frozen concentrate

6. The frozen food of claim 1 wherein the bulking and sweetening agent comprises at least one member selected from the group consisting of (a) non-nutritive bulking agents and artificial sweeteners, (b) non-nutritive bulking agents, artificial sweeteners and nutritive bulking agent sweeteners, (c) nutritive bulking agent sweeteners, (d) nutritive bulking agent sweeteners and artificial sweeteners and (e) non-nutritive bulking agents and nutritive bulking agent sweeteners.

7. The frozen food of claim 1 wherein the bulking and sweetening agent comprises at least one member selected from the group consisting of (a) maltitol and synthetic sweetener, (b) sorbitol and synthetic sweetener, (c) hydrogenated corn syrup and synthetic sweetener, (d) inositol and synthetic sweetener, (e) dextrose and (f) fructose.

8. The frozen food of claim 1 wherein the bulking and sweetening agent consists essentially of at least one non-nutritive bulking agent and artificial sweetener.
